(19) United States
(12) Patent Application Publication
(10) Pub. No.: US 2008/0042416 A1
(43) Pub. Date: Feb. 21, 2008

(54) Airbag with an adaptatively closable vent device

(75) Inventors: Donia Razazi, Madrid (ES); Joana Francisca Tavares Da Silva Vinhas, Villa Nova de Cerveira (PT)

Correspondence Address: LADAS & PARRY, 26 WEST 61ST STREET, NEW YORK, NY, 10023, US

(73) Assignee: DALPHI METAL ESPANA, S.A.

(21) Appl. No.: 11/709,921

(22) Filed: Feb. 22, 2007

(30) Foreign Application Priority Data
Mar. 13, 2006 (ES) 200600637

(51) Int. Cl. B60R 21/16

(52) U.S. Cl. 280/743.2; 280/743.1

(57) ABSTRACT

The invention relates to an airbag comprising an inflatable cushion (11) with the gas produced by a generator when a collisions occurs having a vent hole (13) made in the inflatable cushion (11) which is provided with a device (21) including a part (23) made of flexible material with at least one hole (25) fixed to the inside of the inflatable cushion (11) and incorporating means for allowing the separation thereof from the cushion (11) when the internal pressure in the cushion is lower than a predetermined limit (Pt) preventing it from closing the vent hole (13) and stop doing so when the internal pressure in the cushion (11) exceeds said predetermined limit (Pt) such that it completely or partially closes the vent hole (13) when it adheres to the cushion (11) due to the effect of the pressure.

### FIELD OF THE INVENTION

The present invention relates to an airbag vent device used in vehicles to absorb the blows suffered by drivers and passengers in the event of impacts or collisions.

### BACKGROUND OF THE INVENTION

An airbag basically consist of a folded cushion which is quickly inflated by means of a gas produced by a generator when certain sensor devices detect a collision of the vehicle. In this way, the cushion deploys in front of the driver or a passenger, depending on their location, and prevents their bodies hitting any part of the vehicle.

In the normal cushion deploying operation, the internal pressure caused by the generator upon filling it with gas can be high enough to cause the cushion to be so hard that the occupant rebounds. To prevent this drawback, they have been provided with a vent hole serving to reduce the internal pressure of the cushion and consequently, the possibility of causing damage when they are activated.

In turn, the use of several means for blocking this vent hole to achieve a better control of the internal pressure in the cushion than that achieved only by the variation of the size of the hole is known. In this sense, the use of patches to achieve that the gas does not leave immediately through the discharge hole but when the patch breaks upon reaching a certain pressure inside the cushion is emphasized. The art has proposed different types of patches with different means for controlling their breakage, to a greater or lesser extent, according to a certain resistance to the gas pressure inside the cushion. In this way, the presence of the gas pressure necessary for the cushion to fulfill its protective function is compatibilized with the guarantee that the gas pressure will not reach an excessive value, with a risk for the persons on which the cushion is deployed.

On the other hand, the need has also risen for vent devices which allow increasing the gas outflow according to the specific characteristics of each collision and of the type of passenger affected and in this sense, several solutions of vent devices offering vent holes with an adjustable surface facilitating the increase of the vent area as the internal pressure inside the cushion increases are also known.

A new need which has also risen sets forth the need for airbags which allow reducing the vent area, even eliminating it completely in certain impact conditions which requires sealing means which must work in the opposite sense to the technique known to date. The aforementioned traditional patches had to completely block the outlet hole until the internal pressure of the gas in the cushion did not reach a certain level and afterwards they broke and stopped acting, now the opposite is required: devices which allow closing the vent hole when it is already open when the internal pressure of the cushion reaches certain levels.

Some proposals are known in this sense such as the ones described in patent ES 2182629, U.S. Pat. No. 6,139,048 and patent application US 2004/0090054 using movable elements for closing the vent hole taking advantage of the stresses produced in the cushion, due to the pressure difference together with the difference in the occupant load form. The present invention proposes a solution for this purpose based on different principles.

### SUMMARY OF THE INVENTION

The objective of the present invention is to obtain an airbag with a closable vent device which for highly severe collisions allows the partial or total closure of the vent hole after a first phase in which it is open expelling gas.

This objective is achieved by providing the cushion of the airbag with a device allowing the partial or total closing of said hole when the internal pressure of the gas in the cushion exceeds a predetermined limit (Pt) comprising a part made of flexible material with at least one hole which is fixed at its ends to the inside of the inflatable cushion in the periphery of the vent hole such that the surface of the part is greater than the surface of the cushion delimited by the fixing points of the part and including a mechanism separating the part from the cushion to prevent it from closing the vent hole which is inactivated when the internal pressure in the cushion exceeds a predetermined limit (Pt), the total or partial closing of the vent hole occurring when said part is adhered to the cushion due to the effect of the pressure.

An advantage of the present invention is that the operation of the vent device depends on the internal pressure of the cushion which is very interesting given the possibilities for controlling this variable. The end product is more robust since it does not depend on other features such as stresses/deformations.

Another advantage of the present invention is that the internal pressure of the cushion is more stable as a parameter for controlling the operation of the vent device than other parameters depending on factors such as the manner in which the cushion is deployed or the placing of the occupant with respect to the cushion.

Other features and advantages of the present invention will be disclosed in the following description of an illustrative and in no case limiting embodiment of the object thereof in relation to the attached drawings.

### DESCRIPTION OF THE DRAWINGS

FIGS. 1 and 2 shows schematic elevational views of a cushion of an airbag with a device for closing a vent hole according to a first embodiment of the invention before and after reaching a predetermined pressure (Pt) inside the cushion.

FIGS. 3 and 4 show schematic elevational views of a cushion of an airbag with a device for closing a vent hole according to a second embodiment of the invention before and after reaching a predetermined pressure (Pt) inside the cushion.

### DETAILED DESCRIPTION OF THE INVENTION

In the two embodiments of the invention shown in the figures, the closing device 21 for closing the vent hole 13 of the cushion 11 comprises a fabric part 23 fixed to the cushion 11 in the periphery of the vent hole by means of seams 27 or another suitable fixing means.

The part 23 has at least one hole 25 to allow the passage of gas to the vent hole 13 during the deployment of the cushion which takes place when a collision occurs while the pressure inside the cushion does not reach a predetermined limit Pt.

The device 21 includes a mechanism keeping the part 23 separated from the cushion 11, supporting the pressure exerted by the gas emitted by the generator, until the pressure Pt is reached. Then this mechanism is inactivated and the part 23 adheres to the cushion 11 preventing the outflow of gas completely if the hole 25 is not located in front of the vent hole 13 or partially if it is located such that it partially coincides with the vent hole 13 when the part 23 is adhered to the cushion 11.

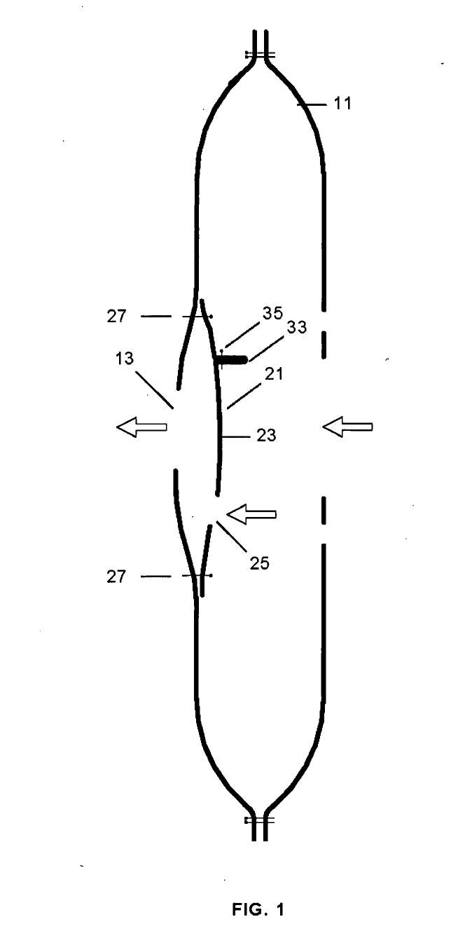

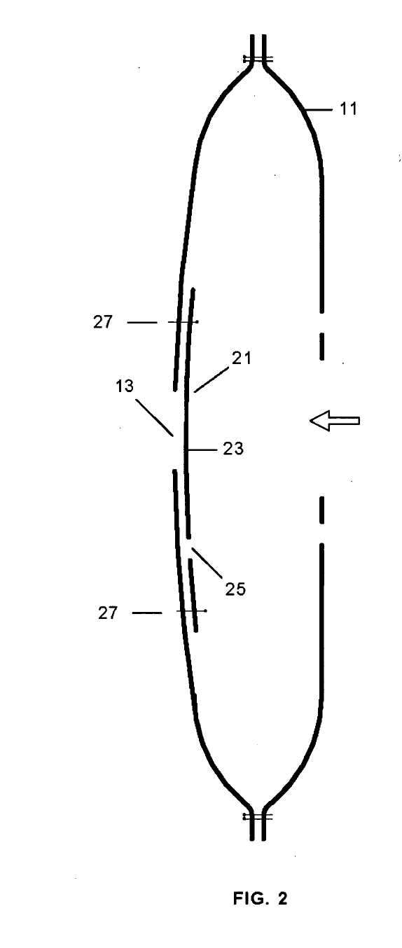

In the first embodiment of the invention shown in FIGS. 1 and 2, this mechanism is formed by a clamp 33 made in the part 23 by means of a seam 35 which, when the area of the part 23 decreases, allows the separation thereof from the cushion 11 and which is made such that it is torn off when the internal pressure inside the cushion reaches the predetermined value Pt.

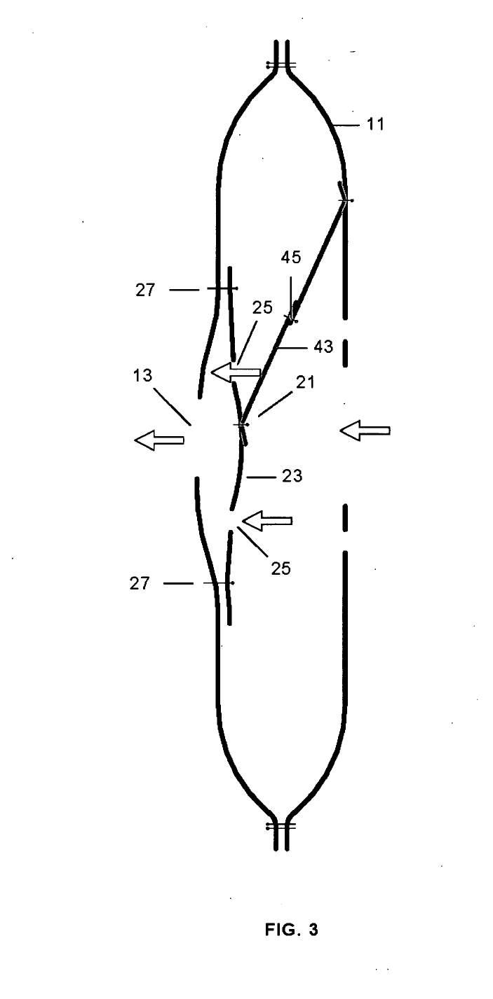

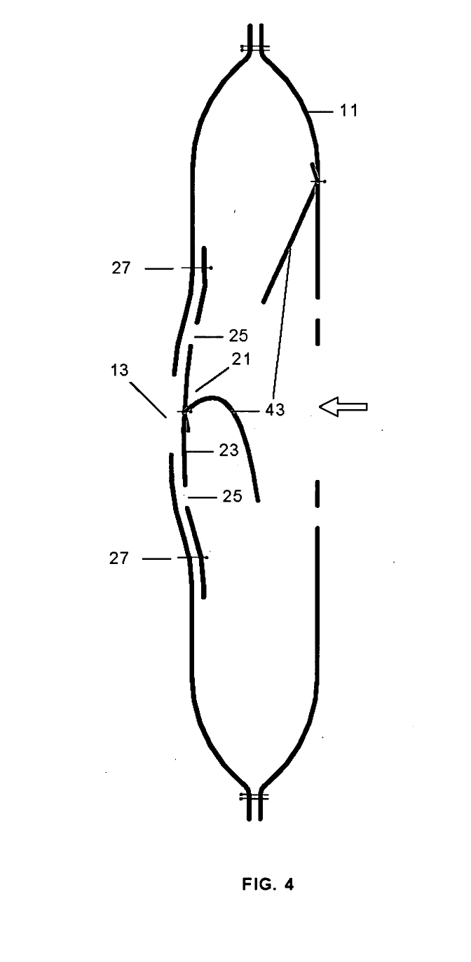

In the second embodiment of the invention shown in FIGS. 3 and 4, the mechanism consists of a strap 43 fixed at one end to the part 23 and at the other end to the cushion 11 including tear-off means 45 provided for being torn off when the internal pressure in the cushion reaches the predetermined value Pt. The tear-off means 45 can be a tear-off seam or a pre-cut. When the pressure rises inside the cushion 11, the gas exerts a stress on the part 23 which is secured to a panel of the cushion 11 by the strap 43, until the latter breaks, releasing the part 23 so that it completely or partially closes the vent hole 13 when it adheres to the cushion 11.

The following are emphasized among the advantages of the present invention.
Making an airbag cushion which can allow the passage of more or less gas according to the specifications without the need for additional components such as sensors. The airbag is adjusted independently.
Achieving the biomechanical criteria by allowing the passage of gas for impacts against barriers and preventing bottoming out in the event of impacts against posts by closing the vent device.
Achieving biomechanical criteria in the event of more severe side impacts.
Having a cushion with a different pressure according to the size of the person, softer cushion with a 5^{th} percentile (low pressure) than with a 95^{th} percentile (high pressure).
Being able to use any type of folding since the vent device is not damaged.

Although several embodiments of the invention have been described and shown, it is evident that modifications comprised within the scope thereof can be introduced therein, and the latter must not be considered limited to said embodiments but to the contents of the following claims.

1. An airbag comprising an inflatable cushion (11) with the gas produced by a generator when a collisions occurs having a vent hole (13) made in the inflatable cushion (11), characterized in that it also comprises a device (21) including a part (23) made of flexible material with at least one hole (25) which is fixed to the inside of the inflatable cushion (11) in the periphery of the vent hole (13) and has a surface that is greater than the surface of the cushion (11) delimited by the fixing points (27) of the part (23), and which incorporates means allowing the separation thereof from the cushion (11) when the internal pressure in the cushion (11) is lower than a predetermined limit (Pt) preventing it from closing the vent hole (13) and stop doing so when the internal pressure in the cushion (11) exceeds said predetermined limit (Pt) such that it completely or partially closes the vent hole (13) when it adheres to the cushion (11) due to the effect of the pressure.

2. An airbag according to claim 1, characterized in that said means consist of at least one clamp (33) made in the part (23) with a tear-off seam (35).

3. An airbag according to claim 1, characterized in that said means consist of at least one strap (43) joined at one if its ends to the part (23) and at the other end to the cushion (11) provided with tear-off means (45).

4. An airbag according to claim 1, characterized in that said part (23) does not have any hole (25) opposite to the vent hole (13) of the cushion (11) such that when the internal pressure of the cushion (11) exceeds the predetermined limit (Pt) a complete closing of the vent hole (13) occurs.

5. An airbag according to claim 1, characterized in that said part has at least one hole (25) opposite to the vent hole (13) of the cushion (11) such that when the internal pressure of the cushion exceeds the predetermined limit (Pt) a complete closing of the vent hole (13) occurs.

6. An airbag according to claim 2, characterized in that said part (23) does not have any hole (25) opposite to the vent hole (13) of the cushion (11) such that when the internal pressure of the cushion (11) exceeds the predetermined limit (Pt) a complete closing of the vent hole (13) occurs.

7. An airbag according to claim 3, characterized in that said part (23) does not have any hole (25) opposite to the vent hole (13) of the cushion (11) such that when the internal pressure of the cushion (11) exceeds the predetermined limit (Pt) a complete closing of the vent hole (13) occurs.

8. An airbag according to claim 2, characterized in that said part has at least one hole (25) opposite to the vent hole (13) of the cushion (11) such that when the internal pressure of the cushion exceeds the predetermined limit (Pt) a complete closing of the vent hole (13) occurs.

9. An airbag according to claim 3, characterized in that said part has at least one hole (25) opposite to the vent hole (13) of the cushion (11) such that when the internal pressure of the cushion exceeds the predetermined limit (Pt) a complete closing of the vent hole (13) occurs.
